(19) United States
(12) Patent Application Publication
(10) Pub. No.: US 2003/0118347 A1
(43) Pub. Date: Jun. 26, 2003

(54) Spectral inversion and chromatic dispersion management in optical transmission systems

(75) Inventors: Paraskevas Papaparaskeva, Sunnyvale, CA (US); Gary L. Woods, Sunnyvale, CA (US); Donald A. Pitt, Portola Valley, CA (US)

Correspondence Address: skjerven morrill LLP, Suite 700, 25 Metro Drive, San Jose, CA, 95110, US

(73) Assignee: SpectraLane

(21) Appl. No.: 10/222,128

(22) Filed: Aug. 15, 2002

Related U.S. Application Data
(60) Provisional application No. 60/342,266, filed on Dec. 21, 2001.

(51) Int. Cl. H04B 10/00

(52) U.S. Cl. 398/147; 398/149

(57) ABSTRACT

A system and method for improving performance of optical fiber networks. The combination of optical spectral inversion and dispersion management enhances performance in optical fiber transmission by controlling the effect of fiber nonlinearities. An optical fiber link, which includes a number of segments or spans, each with a length of fiber and an optical node (typically consisting of at least an amplifier), is provided with at least one spectral inverter, or an optical phase conjugator, connected in the link. Additionally, each span is provided with an amount of dispersion compensation, such as a length of appropriately chosen fiber, to compensate for dispersion as well as other distortion from dispersion's interplay with fiber nonlinear effects. Additional dispersion adjustment is provided in association with the spectral inverter. The location of the spectral inverter (or inverters) and the amount of appropriate dispersion compensation are designed along with other transmission parameters for optimized system performance.

### CROSS REFERENCE TO RELATED APPLICATION

This application claims priority to U.S. Provisional Application No. 60/342,266, filed Dec. 21, 2001.

### FIELD OF THE INVENTION

This disclosure pertains to fiber optic communications, and to fiber optic communications systems with spectral inversion.

### DESCRIPTION OF THE PRIOR ART

Optical communications is a well-known field. Typically, present day optical communications transmit high-bit-rate digital data (2.5-40 Gbps and beyond) over silica glass fiber (or optical fiber, as it is commonly called) by modulating a laser or other optical source. Such fibers are known to have broad bandwidth and can carry therefore multiple high data rate channels at different frequencies, sometimes with a spectral efficiency as high as 1 bit/Hz.

The transmission distance that can be met for a given data rate signal depends on the impairments in a fiber optic transmission system. Typical impairments include loss, chromatic dispersion, polarization mode dispersion, polarization dependent loss, and nonlinear optical effects. Loss is mitigated using optical amplifiers; accumulated amplifier noise places an upper limit on the length a signal can be transmitted for a given set of transmission system properties. Generally, the higher the data rate and the denser the wavelength spacing, the more susceptible a fiber optic transmission system is to impairments.

Chromatic dispersion can be addressed in a number of ways, including: nonzero-dispersion shifted fiber, which has lower dispersion than the more common single-mode non-dispersion shifted fiber; dispersion compensating fiber, which has the opposite dispersion sense as fiber used for transmission and can be added periodically in an optical path to compensate for multiple wavelengths simultaneously; chirped fiber Bragg gratings, which reflect different frequency components of a signal at different parts of the grating, typically for a single wavelength and a limited amount of dispersion, but also for multiple wavelengths; bulk optical devices, which split a signal into spectral components having different optical path lengths; and spectral inversion devices, which use nonlinear optics to generate a frequency-shifted phase conjugate signal. A spectral inversion device inverts the frequency spectrum of a signal; after inversion, the signal impairment accumulated due to dispersion and nonlinearity in a fiber is compensated as it propagates along a remaining fiber having similar dispersion and nonlinear properties.

Nonlinear optical effects increase with increasing optical power in each optical wavelength. Nonlinearities resulting from what is known as Kerr effect occur when the index of refraction in the fiber is altered by the applied optical signal intensity. Such changes modulate the phase of a signal passing through the fiber and thereby impose a “frequency chirp,” which redistributes the signal frequency spectrum. These phenomena take different realizations depending on whether or not they act on single or multiple channels. Examples are self-phase modulation (SPM), in which the optical signal modulates itself, cross-phase modulation (XPM), in which multiple channels cause modulation of neighboring channels, and four-wave-mixing (FWM), where replicas of existing signals are reproduced at specific new frequencies and interfere with existing signals. The changes in phase and frequency distributions are translated to amplitude modulation by the fiber dispersion, yielding significant power penalty in most common square law direct detection systems at the optical receivers.

Impairments due to nonlinear optical effects may be addressed by balancing the maximum power allowed to keep below a certain threshold of nonlinear optical distortion with the minimum power needed to ensure that accumulated noise due to optical amplifiers remains below a certain threshold. A spectral inversion device conjugates the phase of each of the input signals, so that, to a certain extent, the signal impairment accumulated due the optical nonlinearity, typically the Kerr effect, is compensated as the inverted signal propagates along fiber having similar nonlinear optical properties. Systems using spectral inversion devices to compensate nonlinear optical coupling are known.

Effects such as chromatic dispersion and the Kerr nonlinearity both lead to increasing optical signal distortion as a function of transmission distance. One way to overcome this is by use of electronic repeaters, which transform the optical signals into the electrical domain, and reamplify, retime, and regenerate them (what is known as 3R regeneration) before transmitting them optically void of earlier distortions. Such O-E-O (optical to electrical to optical) repeaters are relatively expensive and complicated. Generally, a spectral inversion device can be introduced into a fiber optic communications system to address both chromatic dispersion and nonlinear optical coupling simultaneously, usually in a simpler and more cost effective way as will be described herein.

The known techniques for using optical phase conjugation in a system generally ignore the effects of higher order dispersion (also known as “slope” or β₃), instead approximating the dispersion to be a constant function of wavelength. Thus the wavelength derivative of dispersion, or second order dispersion, is considered to be zero. Also ignored is the interaction of dispersion and nonlinearities in the optical fiber. The focus has been on single channel transmission (SPM distortion), whereas the effects of XPM and FWM in multi channel wavelength division multiplexing (WDM) transmission were not addressed.

In practical WDM systems, the higher order dispersion can accumulate over long distance and acts as a limit on achievable transmission reach. Several earlier methods to counter higher order dispersion were proposed. One such proposal describes an optical communications system using optical phase conjugation where, for instance, the placement of the conjugator may be other than at the precise system (span) mid-point. Hence the slope of the fiber dispersion curve (and higher order dispersion), at least for a specific single channel/wavelength, is compensated by determining the optimal placement of the conjugator to balance the dispersion in each part. Other alternative methods proposed in the above disclosure involved using fiber with a different dispersion function in the second portion after the phase conjugation, or using fiber in the second portion with equal but opposite second order dispersion value to that of the first portion. A similar series of attempts to deal with higher order balances the effects of dispersion on a channel per channel basis by including residual dispersion compensation at the receiver site.

With respect to Kerr nonlinearity treatment, the prior art contains proposals for various system configurations that stem primarily from the analytical theory of phase conjugation, which stipulates that perfect cancellation of such effects can be achieved in a system which exhibits perfect inversion symmetry in power and dispersion profiles on each side of the conjugation point. For example, one proposal involves adjusting the power profiles of optical signals using amplifier spacing, gain, output power, and varying the amplifier type, location and total number of amplifiers used. Such a configuration would create a nearly-perfect symmetry of power profile along the optical fiber and thus the theoretical stipulations of ideal phase conjugation would be met, resulting in nearly-complete cancellation of nonlinearities. Other proposals involve balancing the nonlinear effects on each side of the SI, based on (dispersion*length) product and constant power assumptions, or ratios of other fiber parameters, which are not easily controllable in real systems.

The main problem with prior art is not effectiveness but rather feasibility and practical use in a cost effective manner in real networks. For example, constant power situations are not easy to accomplish since real networks have regular amplifier spacing of orders of tens of kilometers and the fiber loss (typically 0.2 dB/km) spoils any realistic expectations for constant power. Symmetric profiles would require special span configurations (for example two spans with phase conjugation in the center and distributed gain in the second portion, repeated as a basic block) and/or extensive use of costly Raman or other distributed amplifiers. Furthermore, the spacing and gain/output power of amplifiers is not negotiable but rather fixed in real networks since they correspond to the equipment huts in the network where carriers place their transmission equipment. Changing the fiber type (to ones with special dispersion functions and higher order dispersion characteristics) in alternate spans or portion of spans is obviously not feasible in installed networks and undesirable, expensive, and complex even in new installations. The prior art discusses nonlinear impairments arising from single-channel propagation (i.e., self-phase modulation) or else discusses only four-wave mixing in the context of systems containing an older fiber type called dispersion-shifted fiber (DSF). The impairments arising from nonlinear interactions among channels (which are usually dominated by self-phase modulation or cross-phase modulation) in a system that contains standard types of fiber and dispersion management schemes are not addressed. Prior art fails to generalize to multiple wavelength transmission in these cases, which is the case of most significant interest in today's and future WDM systems. Some solutions discussed in the prior art require a great number of parallel conjugators, special fiber type organization, and, sometimes, parallel fibers for transmission. All of these techniques are impractical in current networks.

### SUMMARY

Prior art does not disclose combining the properties of phase conjugation with dispersion management throughout the propagation transmission span to control nonlinear effects in multiple-wavelength systems. A novel and straightforward, simple, inexpensive, and most importantly practical and commercially viable method of benefiting from optical conjugation, in a way that the attempts have overlooked, is disclosed here.

It is known that spectral-inversion techniques have been used in the past in fiber transmission for telecommunications applications for correcting dispersion and canceling SPM (self-phase-modulation) nonlinearity, a phenomenon in which the amplitude of a signal modulates its phase and, as mentioned above, four-wave mixing (FWM) in special cases. The devices used as spectral inverters (or phase conjugators) are either based on third-order nonlinearities, such as those obtained from semiconductor optical amplifiers (SOAs) and highly nonlinear (HNL) fibers, or else based on second-order nonlinearities, such as those obtained from periodically-poled lithium niobate (PPLN) or orientation-patterned gallium arsenide (OP-GaAs). However, a more general problem is addressing all fiber nonlinear effects simultaneously and practically in a wavelength division multiplexing (WDM) system. In addition to SPM, which manifests itself even in single channel propagation, multiple channels give rise to additional nonlinear interference such as four-wave-mixing (FWM) and cross phase modulation (XPM). These effects could take the form of interchannel distortion (the bit stream of one channel affecting bit stream of others), or intrachannel distortion (bits of a single channel stream affecting neighboring bits). With the proliferation of dense WDM, this is actually a significant issue which needs to be addressed before one can expand transmission capacity and distance.

Earlier spectral inversion attempts either failed to provide optimal solutions of both intrachannel and interchannel nonlinear effects in multi-wavelengths systems (they were restricted to single channel SPM type distortion), or such solutions lacked practical implementation feasibility, as described above. For example, the architectures proposed required many idealistic conditions that were only theoretically possible to meet, or, if such ideal conditions were relaxed, multiple changes of installed networks were required.

This disclosure is directed to the use of spectral inversion (SI) in combination with dispersion compensation (supplied by fiber, grating, or other dispersion altering/compensating devices) and other transmission parameters to optimize performance by reducing dramatically the penalties due to fiber nonlinear effects. Furthermore, this method is very straightforward to implement in existing fiber networks without large alterations.

Phase conjugator and spectral inverter (SI) are used interchangeably in this disclosure. An SI is a device which outputs one or more channels which are phase conjugates to the input channel(s). The output channels may have different center frequencies than the corresponding inputs. An SI is based on the principle of nonlinear frequency conversion. The nonlinearity present in the device is described either by a second-order nonlinearity (termed χ⁽²⁾) or a third-order nonlinearity (termed χ⁽³⁾) Examples of devices used as spectral inverters (or phase conjugators) based on χ⁽³⁾ include semiconductor optical amplifiers (SOAs) and highly nonlinear (HNL) fibers; those based on χ⁽²⁾ include periodically-poled lithium niobate (PPLN) or orientation-patterned gallium arsenide (OP-GaAs). In either case, for the device to be efficient, a condition within the device called phase matching must be achieved. One particularly useful method for achieving phase matching is termed quasi-phase matching (QPM). In a QPM device, the nonlinearity inside the SI device is varied spatially in order to achieve phase matching. The nonlinearity variation can be accomplished by, for instance, spatially varying the orientation of ferroelectric domains (as in the case of periodically poled lithium niobate (PPLN) or MgO-doped PPLN); changing the orientation of zincblende crystal axes (as in the case of orientation-patterned gallium arsenide (OP-GaAs)); or varying the nonlinearity by means of an acoustic wave.

In accordance with the invention, there is provided a mostly conventional fiber span. The transmitter is a conventional optical source (modulated laser) that sends information propagating down the fiber. At each segment of the span (typical segment lengths are 30-300 km), the fiber propagation loss is restored with an optical amplifier such as an Erbium Doped Fiber Amplifier (EDFA) or a Raman amplifier. This disclosure discusses Raman amplifiers as if they were discrete devices located within optical nodes of the system; in fact, they can be distributed along the communication fiber itself. One skilled in the art will realize that the following discussion applies to both the case of discrete and distributed amplification. The accumulated dispersion is corrected with a dispersion compensation element, such as dispersion compensating fiber or gratings. One or more spectral inverters are also located at various locations in the span, which perform the optical phase conjugation on the propagating signals.

This provides, in combination, dispersion management and spectral inversion to correct for nonlinear and dispersive effects that degrade performance in a fiber transmission system. The performance is optimized for the right amount of dispersion on a per-segment basis, given a starting value for fiber launch power, which is usually determined by the amplifier noise floor and the transmission distance. Because of the nonlinear effects in the fiber, the amount of compensation may not be the exact amount predicted by simply calculating the fiber dispersion per segment times the number of segments. By either under- or over-compensating dispersion or even removing it completely, depending on the span, better overall signal performance is achieved. Optimization here refers to system performance metrics such as bit-error-rate (BER), or Q factor (related to the signal to noise ratio or SNR) at the receiver. After the dispersion map has been optimized, one or more spectral inverters (SI) are inserted at various positions in the span. The number of SI elements and the exact location(s) is/are case dependent as well. A further dispersion adjustment associated with the SI is used to further optimize performance. One possibility is locating the dispersion adjustment at the location of the spectral inversion (which is convenient from the network operator's point of view), although the dispersion adjustment could be placed elsewhere in the span as well. The dispersion adjustment aligns and/or compresses the signal pulses to achieve adequate cancellation of interchannel and intrachannel nonlinear effects while coping with the effects of higher order dispersion (such as dispersion slope) that could arise from frequency shift during conjugation. At the receiver, more dispersion adjustment is typically used for correction of residual dispersion accumulated during propagation. Other fiber launch powers should also be tested and the optimization described above repeated until the performance is maximized. The insertion of the spectral inversion for fiber nonlinearity suppression often allows for higher launch power, which usually offers advantages in long haul applications.

An additional benefit of using dispersion management in a system containing an SI is to relax the constraints on the frequency noise of the pump laser within the SI. In the prior art it has been shown that using an SI in a system without dispersion management can lead to unacceptably large timing jitter at the receiver. The uncompensated dispersion in such a system converts the frequency noise of the pump laser into timing jitter on the received signals. For example, an uncompensated link might have a net dispersion of 20,000 ps/nm. Thus, in order to maintain maximum timing jitter of 1 ps at the receiver, the frequency width of the pump laser must not exceed a value on the order of 0.05 pm, or a few MHz. This is a fairly stringent constraint on today's monolithic semiconductor lasers. On the other hand, a dispersion-managed system may have a net dispersion on the order of 100 ps/nm, which relaxes the constraint on the laser frequency noise by two orders of magnitude.

### BRIEF DESCRIPTION OF THE DRAWINGS

FIG. 1 shows a block diagram of an optical communications system in accordance with this invention.

FIG. 2 shows an optical phase conjugator subsystem with polarization diversity, based on periodically poled lithium niobate (PPLN) and useful with this invention.

FIG. 3 shows a conventional optical communications system with dispersion compensation.

FIG. 4 shows a plot of spectral inversion span location in one configuration of an exemplary system.

FIG. 5 shows a plot of dispersion adjustment as a ratio of a full span compensation in an exemplary system

FIG. 6 shows a plot of the performance of two configurations of the invention in mixed fiber long haul transmission.

FIG. 7 shows a graphical outline of an exemplary algorithm in accordance with this disclosure.

### DETAILED DESCRIPTION

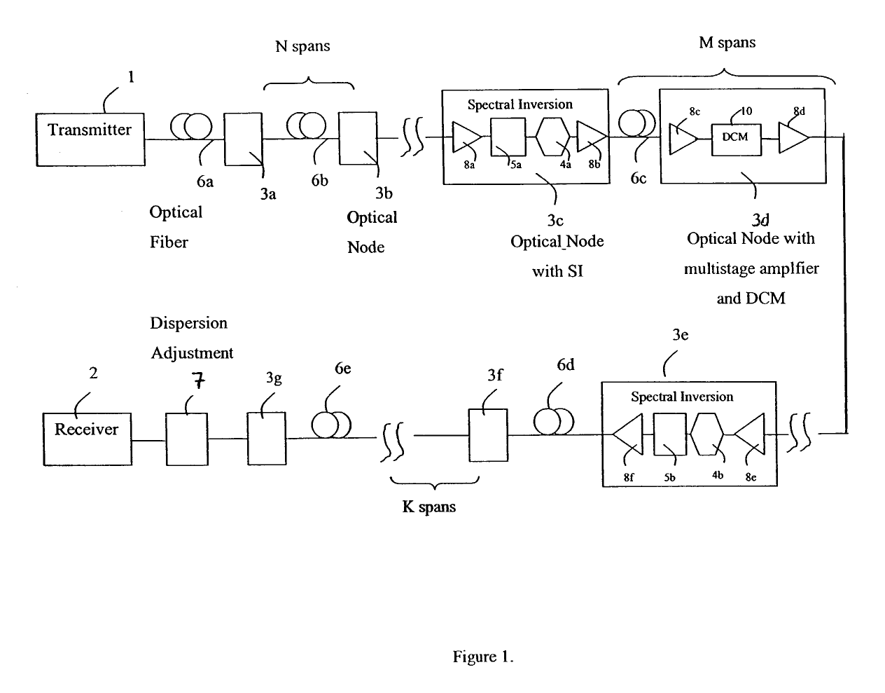

FIG. 1 depicts a transmission fiber span in accordance with this invention. A conventional optical transmitter 1 is an optical source that propagates optical signals in the fiber span. The fiber span is a concatenated series of fiber segments each including a length of optical fiber 6a, 6b, etc., and an optical node 3a, 3b, etc. The fiber type can be of any type and mixed type fiber spans are common in real installed networks. The optical node is an element where network functions are performed depending on the system's particular needs. Examples are (but are not limited to) dispersion compensation elements or modules (DCM), gain flattening filters (GFF), optical performance monitoring (OPM), channel add-drop modules (ADM), optical amplification, spectral inversion, and others as necessary or desired, depicted in detail in various nodes 3a, . . . 3g of FIG. 1. Two examples of an optical node are shown: node 3c with spectral inversion and amplification 8a, 8b functionality and node 3d with amplification 8c, 8d, and a dispersion compensation module (DCM) 10. The accumulated dispersion is usually corrected with a dispersion compensation module (element) 10 at optical nodes 3 and chromatic dispersion adjustment elements 5a, 5b, 7. Spectral inverters 4a, 4b are at nodes 3c, 3e in the span. The number is not limited to the number shown in the figure. The conventional receiver 2 completes the typical end-to-end transmission span.

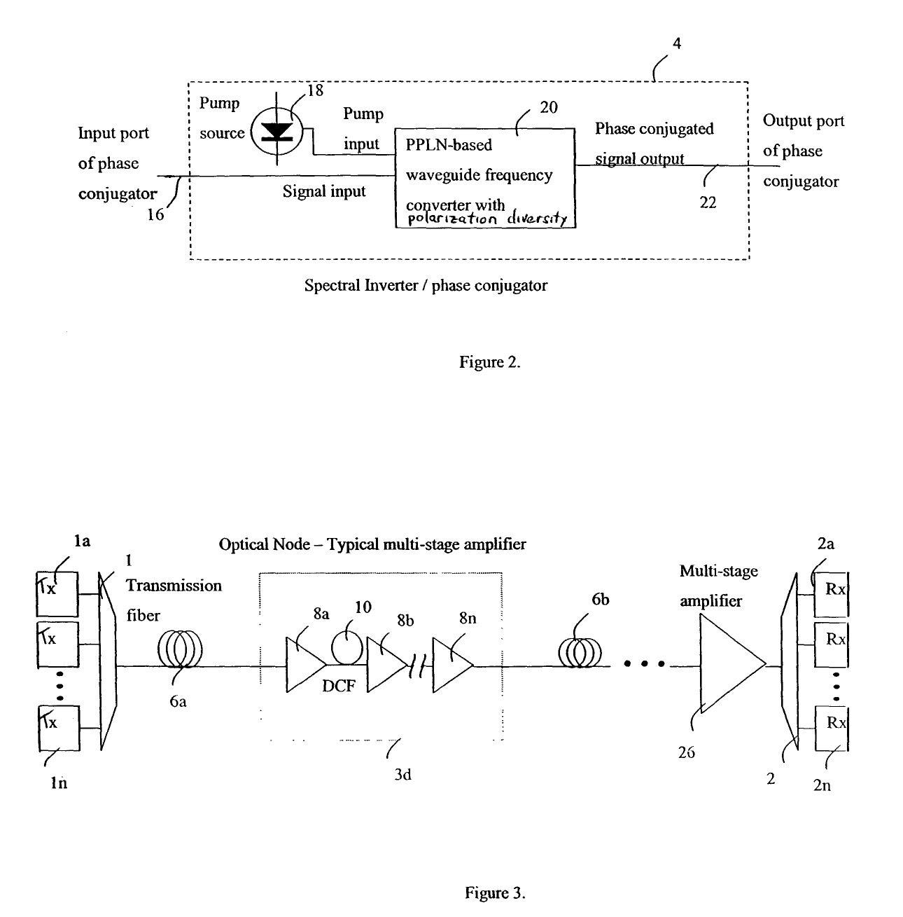

FIG. 2 shows detail of an exemplary spectral inverter 4 of FIG. 1, having a signal input port 16, a pump source (laser) 18, a PPLN waveguide device 20 of a type well known in the art that converts frequency with polarization diversity, and an optical output port 22. This SI 4 is conventional, and may be a multichannel or single channel device. PPLN is a type of quasi-phase matching material, of which others may be used alternatively.

For comparison, FIG. 3 shows a conventional fiber transmission system with multiple channel transmitters and receivers similarly labeled as in FIG. 1. The propagation loss is restored at node 3d with mid-stage EDFA amplifiers 8a, 8b, . . . , 8n with intervening dispersion compensating fiber (DCF) 10 for removing chromatic dispersion accumulated in the transmission fiber 6a. Also shown in FIG. 3 is more detail of transmission source with multiplexer 1, having multiple transmitters 1a, . . . , 1n (one for each channel) and a receiver section with demultiplexer 2 and receivers 2a, 2n, and a multistage amplifier 26.

Note that in the FIG. 1 system, in contrast to prior art, no assumptions on spacing, gain or output power are required for the amplifiers, as lossless or symmetric power profiles are not a prerequisite. Also, no special fiber types or special placement are assumed. Such idealities would improve performance, but practical systems may be built in the absence of such assumptions. Also note the possible inclusion of per-segment dispersion management devices helps provide the performance improvement of the current system capitalizing on the spectral inversion properties.

The following describes a method to configure a system as in FIG. 1. Specific examples that show the applications of the method are included with performance illustrations. Given a network with certain transmission parameters, such as fiber type, transmission distance, data rate, number of channels, channel spacing, launch power, amplifier spacing, waveform type, and other link characteristics, one finds the optimal per segment dispersion compensation required to maximize the receiver signal quality at the nodes in FIG. 1 and typically preceded by the transmission fiber 6. To find the optimal amount of dispersion compensation, the well-known differential equations that govern fiber propagation (Nonlinear Schrodinger equation, NLS) are solved for the various candidate compensation values. Typically, a numerical simulation is undertaken since there is no closed form solution for the most general cases. Experimental lab or field work, although more cumbersome, could also provide the same answer. Without fiber nonlinearity, the amount of dispersion compensation needed on a per segment basis can be found easily as a linear function of distance. This exact compensation value can be used as a starting point. The numerical equations are solved and the signal quality is measured. Because of fiber nonlinearities and their interplay with dispersion, one usually finds that the best compensation value is not the full 100% amount calculated assuming linear effects only. To optimize performance, the dispersion value is perturbed around the exact expected value, typically in increments of 5% in either direction, overcompensation or undercompensation. The simulation is carried out again and the results stored. There will be an optimal point at which the Q value, or signal quality, is maximized. That should be the value ideally used to build the network with the above parameters and assumptions.

Classical network design traditionally stops at this stage. The performance may or may not be adequate depending on the span. To further improve the system margins and gain Q benefit, spectral inversion can be introduced as suggested in this disclosure. In the above mentioned dispersion optimized network, one can introduce the added spectral inversion 4 to reduce the nonlinear effects of SPM, XPM, and FWM in the fiber. The location of the spectral inversion 4 varies depending on the various assumptions of the link. The goal is to reverse most of the nonlinear effects that were created pre-spectral inversion with the effects created post-spectral inversion. The starting point is usually to place the SI at the link mid-point (or amplifier closest to the mid-point) and perturb the position of the SI for optimization of system performance. If all aspects of the system were ideal, the mid-point would be the best location. Ideal in this case means having a fiber with no dispersion slope; having a power profile that is symmetric about the mid-point, which implies distributed gain in the second half of the link; and having the dispersion and nonlinearity symmetric about the midpoint. Because of many nonidealities in most networks, including power profile, dispersion, fiber type and nonlinear interactions, a point other than the mid-point could provide better results. In practical installed networks, the location of the spectral inversion would be at one of the optical nodes 3 where the dispersion compensation also is located. As such, the exact mid-point may not be available even if it were the best point of symmetry.

Another parameter that helps performance significantly is the dispersion compensation associated with the spectral inversion 5. Typically the compensation takes place at the spectral inversion point (prior or after), but other locations may be used as well, including at the receiver. Because the spectral inversion usually results in signal frequency translation, a dispersion compensation (adjustment) provides better symmetry on each part of the propagation for the set of channels that underwent frequency shift (spectral inversion does not compensate for dispersion slope, also known as β₃, and some higher orders of dispersion, so a high-order dispersion compensator, such as a grating, is sometimes needed for high data rates). In addition, to cancel some of the interchannel nonlinear effects such as XPM, temporal re-alignment of signal pulses from channels at different wavelengths is needed to match the nonlinear interactions prior to the spectral inversion with those which occur after the spectral inversion. The dispersion adjustment associated with the SI helps accomplish this as well. The exact amount to optimize performance is again variable and dependent on the span parameters. Numerical simulations are a method to find the correct amount. One would find the location/dispersion adjustment of the spectral inverter and then try neighboring locations by re-examining the dispersion adjustment as well in a two dimensional space optimization problem. At the receiver 2, there may be a need for an additional dispersion compensation element 7 since the amount of adjustment that was selected at the inversion point minimizes the nonlinear degradation but leaves the pulses dispersed usually, and thus at the receiver the linear group delay should be removed.

This procedure is repeated for a range of values for fiber launch power until the best performance is achieved. The optimal launch power in the presence of spectral inversion is one that most effectively balances distortion from fiber nonlinear effects and the noise floor from other sources, most often optical amplifiers.

The following discloses an exemplary optimization procedure. This example has a specific sequence of procedural steps for illustration, although as with any multi-dimensional optimization technique, the order of the steps could be different. Also, the initial points and quantization resolution for various optimization parameters are chosen for convenience and could vary widely for other systems.

Given a fiber network with an optical transmitter, a transmission medium, and a receiver, a desirable performance metric (such as BER or Q) could be optimized with the use of spectral inversion and dispersion management as follows:

1) Assume fiber launch power to start the optimization iteration. Reasonable guidance can be derived from the amplifier noise floor based on transmission distance

2) Set the dispersion compensation in each span to 100% of the correct amount assuming no nonlinearity. (Arbitrary initial condition).

3) Solve the numerical equations for pulse propagation, or perform experiments in the lab or field, for this system configuration, and record the performance metric.

4) Repeat step 3, varying the amount of dispersion compensation at the receiver until the performance is optimized; set the dispersion compensation at the receiver to this value; continue to 5.

5) Repeat steps 3-4, varying the per-span dispersion compensation until the performance is optimized; set the per-span dispersion compensation to this value.

6) Place the SI at the amplifier closest to the midpoint of the system

7) Set the dispersion in the span containing the SI to be 50% of the correct amount assuming no nonlinearity. (Arbitrary initial condition)

8) Repeat steps 3-4, varying the amount of dispersion in the span containing the SI, until the performance is optimized; set the dispersion in the span containing the SI to the optimal value; continue to 9

9) Repeat 8, varying the location of the SI until the performance is optimized; set the location to the optimal value; continue to 10

10) Repeat all steps starting with step 1, varying the launch power until the performance is optimized.

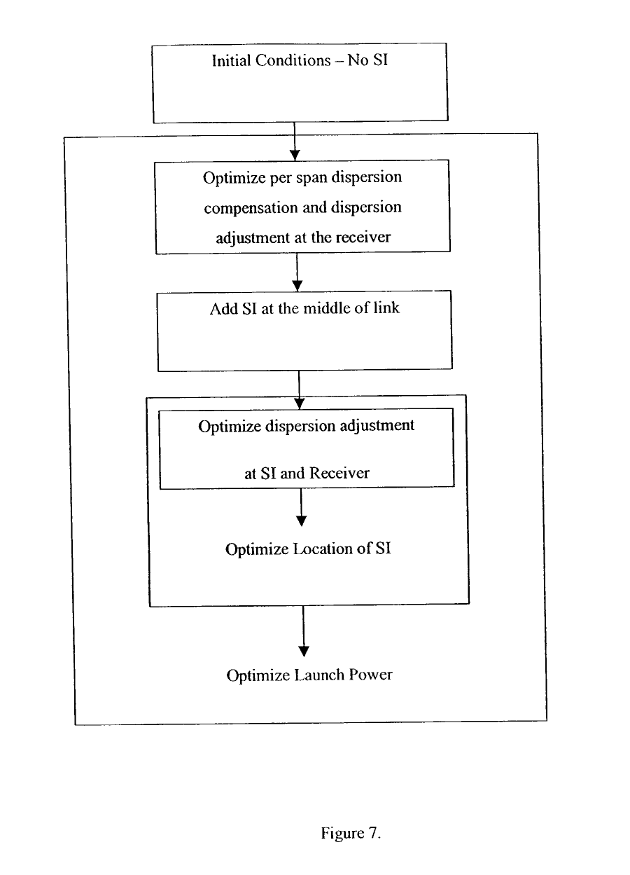

A flow chart of the above procedure is shown in FIG. 7.

The above process can be repeated for several spectral inversions in the link. If the link budget needs to be improved further, one could divide the span into several parts, each having a spectral inversion with its own optimized location and dispersion compensation. Multiple spectral inverters provide better performance since they operate in shorter sub-links where asymmetry and other non-idealities of various parameters are less crucial. The approach can be used, for example, to retain a minimum acceptable BER threshold throughout very long transmission distances. Note that the most general optimization method ideally would be to optimize independently all transmission variables (in a multi-dimensional space sense).

The above method is only an example for the most easily managed and practically accessible parameters: the per-segment dispersion, the spectral inversion location, the dispersion adjustment in the span, the receiver dispersion adjustment, and the fiber launch power. In this illustrative procedure, we chose to set one variable, the per segment dispersion, to its optimal value determined without spectral inversion (holding the other dimensions constant), even though potentially that value may not be the true optimal in a 5-dimensional sense where all variables are allowed to vary simultaneously. The reason from a practical point of view is that most networks already have dispersion compensation elements installed, and hence that degree of freedom may not be available for independent optimization. The performance improvement is dramatic nonetheless. Because of the robustness of the optimization method, even in non-optimal inline dispersion networks, a configuration can be usually found with appropriate, launch power, dispersion adjustments and SI location to yield significant benefits in performance. In most cases, it was actually found that the performance attained in similar configurations approach the theoretical limit set by the amplifier noise floor which is derived assuming no nonlinear effects are present.

The procedure described is not limiting. The order in which the particular variables are perturbed is not limiting but merely illustrative. Also, for instance, the perturbation values mentioned are, of course, just examples. It is to be understood that a problem of this type is not believed to be susceptible to a closed form solution, and hence the presently outlined algorithmic method is the current recommended approach to optimization.

The following are exemplary systems configured using the above approach.

### EXAMPLE

### SMF, 10 Gbps Transmission

This example is a network of 16 segments of single mode fiber SMF28 (single mode fiber with high absolute chromatic dispersion characteristics) fiber at 80 km per segment (16 dB loss per segment). Five channels at 10 Gbps NRZ data rate, spaced 25 GHz apart, are to be transmitted. The launch power is assumed 0 dBm per channel and is excluded from independent optimization for simplicity. Given the above parameters, we describe below how one would use the method to increase the system margin and obtain a significant Q benefit.

The network was first optimized with the conventional dispersion correction methods. The optimal level of dispersion required per segment was found to be 95% of the full compensation (the amount one would expect assuming only linear fiber effects). At the receiver, the signal quality measured by the Q factor was 15.5 dB.

To improve on the above system margin, a phase conjugator was inserted at the mid-point after the 8th segment to perform the spectral inversion of the incoming signals. By varying the dispersion compensation at the 8th segment (just prior to spectral inversion), an optimal point of 10% dispersion (relative to full compensation) was found to provide the best performance. The remaining 15 segments continue to have the usual 95% dispersion compensation assumed in the classical optimization. To determine whether additional improvement is possible, neighboring locations are tried for the SI as well. It was actually found that the 9th segment was a better place for the spectral inversion. The best dispersion adjustment was still at 10%. At the receiver, a 56 km segment of SMF (70% of the nominal 80 km segment) was used to remove linear residual (negative) dispersion that resulted from the adjustment at the 9th segment. Alternatively, one could adjust the last dispersion compensation element accordingly so that no positive dispersion is required. This approach yielded a final Q of 22 dB, a significant improvement over the prior art dispersion-only management case of FIG. 3.

### EXAMPLE

### TrueWave, 40 Gbps Transmission

This example is for a network of 16 segments of TrueWave fiber (single mode fiber with lower absolute chromatic dispersion relative to SMF 28) at 80 km per segment (16 dB loss per segment). Five channels at 40 Gbps RZ data rate, spaced 100 GHz apart, are transmitted with fixed launch power of 3 dBm per channel.

The optimal level of dispersion required per segment was found to be 104% relative to full compensation (hence overcompensation). At the receiver, the signal quality measured by the Q factor was 16 dB.

A phase conjugator (SI) was inserted at the span mid-point after the 8th segment to perform the spectral inversion of the incoming signals. No improvement could be obtained in neighboring locations so the spectral inversion is kept at the mid-point. An optimal amount of 20% dispersion adjustment prior to the spectral inversion (relative to full compensation) was found to provide the best performance. The remaining 15 segments are at 104% dispersion compensation. At the receiver, dispersion compensation optimization results in a final Q of 20.5 dB, a sizable improvement over the prior art.

### EXAMPLE

### Mixed Fiber, 10 Gbps Transmission

This example demonstrates the importance of the parameter space choices in the spectral inversion configuration for optimization of signal quality. The system is a mixed fiber span, having of 24 segments of SMF28 fiber and 8 segments of TrueWave fiber for a total of 2560 km transmission distance (32×80 km). Five channels spaced at 25 GHz at constant launch power of 0 dBm per channel were assumed. (These simulations use conventional computer software for optical design.)

The optimal values for dispersion were 95% for the SMF28 fiber portion and 120% for the TrueWave fiber portion (relative to the expected value for dispersion compensation from linear assumptions). The Q performance with only dispersion optimization was found at the receiver to be 11 dB.

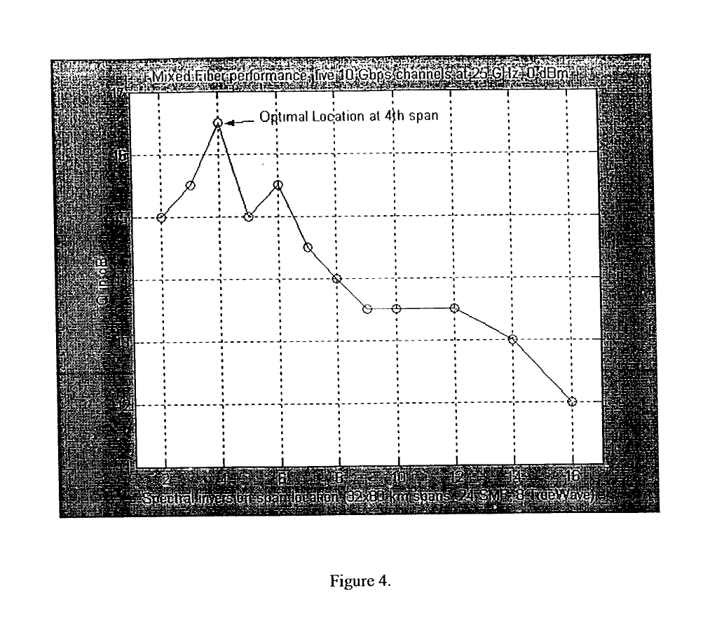

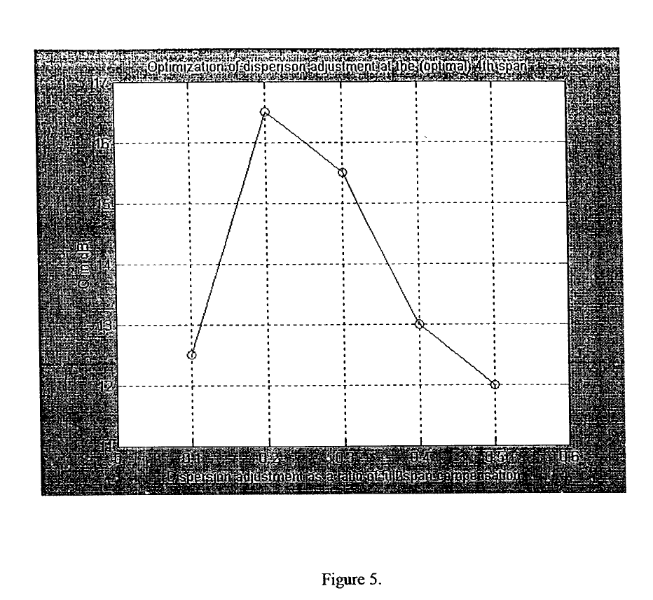

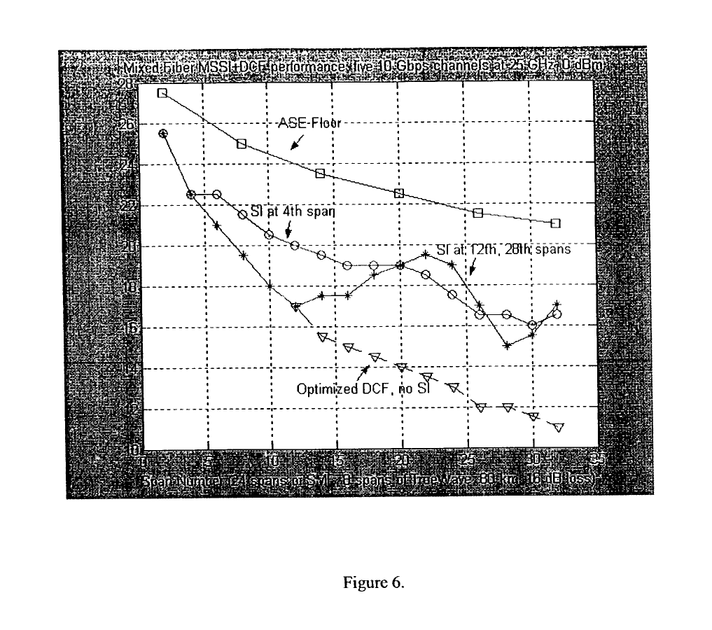

Adding two spectral inversions, at the mid-point of each fiber portion (12th and 28th segments), with appropriate dispersion adjustment at the optical nodes huts (20% and 60%, respectively), yielded a 17 dB signal Q factor at the receiver. To design a more efficient system, the goal is to approach the same benefit with only one spectral inversion. It was found that placing one phase conjugator at the 4th segment with 20% dispersion adjustment was enough to result in 16.5 dB Q, very close to the multiple inverter case. Illustrations of the results are shown in the plots of FIGS. 4 through 6. FIG. 4 shows the Q performance versus the spectral inversion placement. Note the significant asymmetry that is required in this mixed fiber case to optimize the location of the single spectral inversion. FIG. 5 shows the optimization of the dispersion adjustment at the optimal location (4th segment found in first plot) prior to spectral inversion. The ratio of 0.95 relative to full dispersion compensation found in the classical optimization (per segment) is reduced to 0.2 at the spectral inversion. Both cases assume that at the receiver a dispersion optimization is also performed to remove residual group delay on the signal. FIG. 6 shows the various Q measurements throughout the span and includes the amplified spontaneous emission (ASE) noise floor in the absence of nonlinear fiber effects. Note the 5-6 dB performance improvement of the examples over the prior art that has no spectral inverters. The importance of the SI location and the number of spectral inversions is demonstrated in the figure as well. Depending on the span design, and the Q threshold one has to achieve at various add-drop points in the network, various combinations of SI architectures are possible.

This disclosure is not limiting; further modifications will be apparent to one skilled in the art in light of this disclosure and are intended to fall within the scope of the invention and the appended claims. For example, other network transmission parameters as mentioned above could also be modified for further performance improvement. Changing the fiber type to other appropriate types, and/or the amplifier spacing for more flexibility could be incorporated in the optimization. Any such extensions are obvious and do not limit the method described. The examples here are of parameters that are simple to adjust in typical installed networks.

What is claimed is:

1. An optical communications system comprising:
at least one optical transmitter;
a transmission path containing one or more optical fiber spans and one or more optical nodes,
at least one of said node or nodes containing at least a dispersion management element; and
at least one optical receiver coupled to receive signals transmitted by the transmitter(s);
said transmitter(s) being coupled via the said transmission path to said receiver(s), wherein one or more spectral inverters is(are) introduced and configured to satisfy a desired transmission performance metric.

2. The system of claim 1 wherein one or more nodes include at least one optical amplifier.

3. The system of claim 2 wherein the optical amplifiers are one of an EDFA or Raman amplifier or semiconductor optical amplifier or optical parametric amplifier.

4. The system of claim 1 wherein the dispersion compensation element is one of a dispersion grating, or length of optical fiber, or etalon device.

5. The system of claim 1 wherein one or more nodes further include network management functions such as gain filter flattening (GFF), optical power monitoring (OPM), channel optical add-drop (OADM), wavelength switching and routing, regeneration.

6. The system of claim 1 wherein the dispersion compensation element compensates for an amount of dispersion other than the 100% of the amount provided by the optical fiber in the segment.

7. The system of claim 1 wherein the spectral inverter is a multichannel optical spectral inverter.

8. The system of claim 1, wherein the spectral inverter is a single-channel optical spectral inverter.

9. The system of claim 1, wherein the spectral inverter includes a quasi-phase matched material.

10. The system of claim 9, wherein the spectral inverter includes PPLN material.

11. The system of claim 1, wherein the spectral inverter is located approximately mid-way between the transmitter and the receiver.

12. The system of claim 1, wherein at least one additional spectral inverter is coupled between the transmitter and the receiver.

13. The system of claim 2 wherein the spectral inverter is in the same enclosure as at least one of the amplifiers.

14. The system of claim 1 wherein the optical fiber is a single-mode fiber.

15. The system of claim 1 wherein at least some of the optical fiber is a multi-mode fiber.

16. The system of claim 1, further comprising a chromatic dispersion adjustment element associated with the spectral inverter.

17. A method of configuring an optical communications system, comprising the acts of:
determining a number of segments to be located in a span between an optical transmitter and an optical receiver, each segment including a length of optical fiber and an optical node;
determining a location of a spectral inverter in the span;
determining an amount of chromatic dispersion compensation to be provided in each segment of the span in accordance with the amount of spectral inversion provided;
determining the fiber launch power at a plurality of locations in the span; and
determining characteristics of at least one other transmission parameter of the system.

18. The method of claim 17 wherein one or more optical nodes include at least an optical amplifier.

19. The method of claim 17 further comprising the act of determining an amount of dispersion compensation to be provided per segment throughout the span.

20. The method of claim 17 further comprising the act of determining the location of at least one additional spectral inverter in the span.

21. The method of claim 17 further comprising the act of determining fiber launch power throughout the span.

22. The method of claim 17 further comprising the act of repeatedly simulating, experimenting, or modeling parameters of the system to satisfy a performance metric.

23. The method of claim 18 wherein the optical amplifiers are one of an EDFA or Raman amplifier or semiconductor optical amplifier or optical parameter amplifier.

24. The method of claim 17 wherein the dispersion compensation is provided by one of a dispersion grating, length of optical fiber, or an etalon based device.

25. The method of claim 24 wherein the dispersion element compensates for an amount of dispersion other than the 100% of the amount provided by the optical fiber in the segment.

26. The method of claim 17 where the spectral inverter is a multichannel optical spectral inverter.

27. The method of claim 17 where the spectral inverter is a single channel optical spectral inverter.

28. The method of claim 17 wherein the spectral inverter is located approximately mid-way between the transmitter and the receiver.

29. The method of claim 17 wherein at least one additional spectral inverter is coupled between the transmitter and the receiver.

30. The method of claim 17 wherein the optical fiber is a single mode fiber.

31. The method of claim 17 wherein at least some of the optical fiber is a multi-mode fiber.

32. The method of claim 17, further comprising the act of providing additional chromatic dispersion compensation associated with the spectral inverter.

33. The method of claim 17 wherein the method maximizes the distance*capacity product in the system.

34. The method of claim 17 wherein the method allows more efficient wave division multiplexing spectrum efficiency through tighter channel spacing transmission.

35. The method of claim 17 wherein the method enables higher data transmission per channel of the system.

36. The method of claim 17 wherein the method enables longer reach in fiber data transmission.

37. The method of claim 17 wherein the method allows flexible BER or signal quality Q management by maintaining specified minimum performance throughout the span.

38. The method of claim 17 wherein the method allows improvement of the amplification utilization in the span.

39. The method of claim 17 wherein the method enables differentiated grouping of transmitted signals in the span.

40. The method of claim 17 wherein the method provides for forward error correction (FEC) enhancement.

41. The method of claim 17 wherein the method enables the use of non on-off keyed signal waveform formats in data transmission.

42. The method of claim 17 wherein the method allows use of dispersion shifted optical fiber (DSF) or near-zero absolute dispersion optical fibers in the span.

43. The method of claim 17 wherein the method improves performance in a mixed fiber type system.

44. The method of claim 17 wherein the method improves performance in a mixed data rate type system.

45. The method of claim 17 wherein the method improves performance in a mixed channel spacing system.

46. The method of claim 17 wherein the method increases system performance margin.

47. The method of claim 17 wherein the method allows increased launch power in the span.

48. The method of claim 17 wherein the method allows increased segment lengths.

49. The method of claim 17 wherein the method allows for compensation of higher order dispersion accumulated in the span.

51. The system of claim 1 adapted for terrestrial optical fiber transmission.

52. The system of claim 1 adapted for undersea optical fiber transmission.
